(19) United States
(12) Patent Application Publication
(10) Pub. No.: US 2013/0032220 A1
(43) Pub. Date: Feb. 7, 2013

(54) SYSTEM AND A METHOD FOR THE FLUSHING OF AIR CONDITION SYSTEMS

(71) Applicant: Louis Cording, Sonderborg (DK)

(72) Inventor: Louis Cording, Sonderborg (DK)

(21) Appl. No.: 13/521,291

(22) PCT Filed: Jan. 19, 2011
(86) PCT No.: PCT/DK11/00002

§ 371 Date: Oct. 15, 2012

(30) Foreign Application Priority Data
Jan. 22, 2010 (DK) PA 201000048

(51) Int. Cl. B08B 9/032

(52) U.S. Cl. 137/15.04; 134/166 C

(57) ABSTRACT

A service station, for the filling, emptying and flushing of an air conditioning system in a vehicle, is coupled to the air conditioning system and includes: a cabinet in which a pipeline for transporting the coolant connects a first port with a compressor, cooling unit, an internal cylinder for storing the coolant, as well as a second port. A heated flushing accumulator is arranged inside the service station between the first port and the compressor.

### BACKGROUND OF THE INVENTION

1. Field of the Invention

The present invention relates to a system and a method for performing service and flushing of air conditioning systems, especially mobile air conditioning systems in vehicles, such as cars and trucks, etc.

2. Description of the Related Art

Today, air conditioning systems (A/C systems), e.g. in vehicles such as cars, buses or trucks, etc. contain coolants which are not inflammable. The coolants are added during the manufacture of the vehicle, and the A/C systems in the vehicles are serviced and repaired from time to time. Equipment for performing this is known.

The most commonly used coolant at present is 1,1,1,2-tetrafluoroethane, which is commonly known as R134a. However, owing to the high green house effect (GWP, Global Warming Potential) of R134a, it is not allowed to use R134a as a coolant in new vehicles after 1 Jan. 2011.

A substitute coolant having a permissible low GWP value has been developed, which, unfortunately, is inflammable. The service stations used for the filling, emptying and flushing of the new inflammable coolant must therefore fulfill the ATEX Directive 94/9/EU concerning equipment and protective systems intended for use in potentially explosive atmospheres or inflammable atmospheres. This EU directive, in short ATEX, implies that the service station used for the filling and emptying of A/C systems, especially mobile A/C systems in vehicles, must comply with considerable technical requirements when the inflammable coolant is to be added to the A/C system, or when service is performed on the A/C systems containing the inflammable coolant.

In accordance with ATEX, a zone 2 is classified as an area in which, normally, no inflammable atmosphere is present—only in case of an accident, and then only briefly. Zone 2 is the lowest area classification according to ATEX.

A component which contains an inflammable medium and also has a connection or a gasket, which is not technically tight, is considered to have a zone 2 in a radius of 1 m around the connection or gasket. A gasket is normally tight, but may become leaky because of wear and/or ageing. Therefore, according to ATEX, a zone 2 atmosphere will by definition be present around the gasket.

When maintenance is performed on A/C systems, the coolant is evacuated from the A/C system prior to service or repair. The evacuation is normally performed by suction.

When performing service and/or repair on A/C systems operating on an inflammable coolant, the service systems must therefore be suitable for use in a zone 2 environment according to ATEX. In other words, zone 2 requirements should be fulfilled at least inside the service station.

In those cases where the A/C system includes components which are to be replaced, there is a procedure where the oil and/or particulates content in the component itself, or in the entire air conditioning system, has to be flushed out by means of a so-called flushing process. So far, so-called flushing kits have been used for this, said kits being supplied to the service stations as “add-ons” for mounting between the A/C system and the service station during the flushing process. With the prior art technology, as mentioned, the flushing kit is mounted between the mobile A/C system and the service station. The primary purpose of this flushing kit is to catch all the coolant which is flushed through the A/C system from the service station in liquid form, as well as the oil and any solids or particulates which are entrained by the flushing flow of the coolant. After collection, it is then the task of the service station to empty the coolant from the accumulator of the flushing kit in gas form, thereby leaving the oil in the accumulator. Prior art service stations for mobile for A/C systems usually contain their own suction accumulator, a heated suction accumulator, which basically has the same function as these flushing accumulators in the flushing kits—they are just smaller, since they are not intended to receive any large amounts of coolant and also just smaller amounts of oil when a normal service is carried out on a mobile A/C system, i.e. when the A/C system is only to be emptied.

Since, however, the new coolant is inflammable, this flushing kit will have to comply with the special requirements in ATEX, which also apply to the service station, since a zone 2 will be present around every connection, i.e. also around the connections between the external flushing kit and the service station.

In accordance with the international standard IEC/EN60079-15 regarding electrical equipment for use in explosive or inflammable atmospheres, the inflammable area, e.g. a zone 2 area, may be shielded from the environment and the zone 2 area may be subjected to ventilation.

### BRIEF SUMMARY OF THE INVENTION

An object of the invention is to provide a system which may be used for the filling, emptying and especially flushing of A/C systems, such as mobile A/C systems, which system may be used during service and/or maintenance of A/C systems containing inflammable coolants.

Another object of the invention is to provide a simplified system which may be used for filling, emptying and especially flushing of A/C systems, which eliminates the need for the flushing kit, including the externally mounted flushing accumulator. Still another object of the invention is to provide a system in which also a suction accumulator present in the coolant circuit in the service station may be eliminated.

An object of the invention is also to provide a method for flushing of A/C systems, especially a method for A/C systems operating on inflammable coolants. Additionally, an object of the invention is to provide a method of flushing A/C systems which is less time consuming, and which eliminates decrease in the capacity of the compressor during the flushing process.

The above mentioned objects are achieved by a method of flushing air conditioning systems, which may be used for flushing air conditioning systems in vehicles or similar mobile air conditioning systems, which are operating on an inflammable coolant, comprising the steps of flushing the coolant in liquid form from an internal cylinder in a service station through the air conditioning system, extracting a mixture of gaseous coolant and oil and/or particulates, which have been flushed from the air conditioning system, and passing the mixture to a heated flushing accumulator mounted inside the service station, separating the oil and/or particulates from the coolant in the heated flushing accumulator by the compressor sucking gaseous coolant from the heated flushing accumulator, condensing the coolant by cooling, and transferring the liquefied coolant to the internal cylinder. The method enables a less time consuming flushing procedure and enables the flushing of A/C systems, which are operating on an inflammable coolant.

It is expedient that the liquid coolant enters the air conditioning system through a service port connected to the liquid side of the air conditioning system and leaves the air conditioning system in gaseous form, including any entrained oil and/or particulates, through a service port on the gas side of the air conditioning system.

It is also expedient that the coolant is cooled in a heating coil mounted in the heated flushing accumulator, which simultaneously heats the mixture of coolant, oil and/or particulates present in the heated flushing accumulator.

Other expedient embodiments of the method further comprise emptying oil and/or particulates from the heated flushing accumulator.

The object of the invention is also achieved by a system for the filling, emptying and flushing of air conditioning systems which is useful for flushing air conditioning systems in vehicles or similar mobile air conditioning systems, which are operating on an inflammable coolant, and which comprises a service station, intended to be coupled to the air conditioning system during a filling, emptying and/or flushing procedure, wherein the service station comprises a cabinet in which a pipeline for transporting the coolant connects an first port with a compressor, cooling means, and an internal cylinder for storing the coolant as well as a second port, and wherein a heated flushing accumulator is arranged inside the service station and between the first port and the compressor in order to catch the coolant, which is flushed from the service station and through the A/C system, and to heat the coolant present in the heated flushing accumulator and simultaneously to cool the coolant in the heating coil for condensing the hot, gaseous or partially liquefied coolant prior to storage in the internal cylinder.

According to the present invention, the externally mounted flushing and the internal suction accumulator used in the prior art service station may be omitted, as their function will be taken over by the heated flushing accumulator. Since the externally mounted flushing kit is omitted the gaskets and/or connections between related to the flushing kit are avoided. This results in fewer zones 2 areas outside the service station and the new system is thus fulfilling ATEX requirements. Additionally, when the external flushing kit does not have to be mounted between the service station and the MAC, handling time is moreover saved—i.e. the actual flushing process is faster and easier. The simplified construction of the service station and the elimination of the external flushing kit also result in a simplified system which is less expensive to produce.

The heated flushing accumulator preferably comprises a heating coil through which gaseous coolant, which has been heated in the compressor, is intended to flow. The heating coil uses waste heat present in the gaseous coolant and counter acts the cooling effect, and the resulting reduction in the capacity of the compressor which would occur when the compressor sucks a cooled gaseous coolant from the prior art externally mounted flushing accumulator.

The cabinet of the service station is preferably gas tight, and it is expedient that the heated flushing accumulator further comprises a valve mounted on an outlet through which oil and/or particulates are withdrawn from the heated flushing accumulator.

It is preferred that the pipe line comprises valves which are mounted between an outlet on the internal cylinder and the second port.

### BRIEF DESCRIPTION OF THE DRAWINGS

FIG. 1 shows a diagram of a prior art service station for the filling, emptying and/or flushing of mobile A/C systems operating on R134a.

FIG. 2 shows a diagram of the inventive new service station for the filling, emptying and for flushing of mobile A/C systems operating on an inflammable coolant.

### DETAILED DESCRIPTION OF THE INVENTION

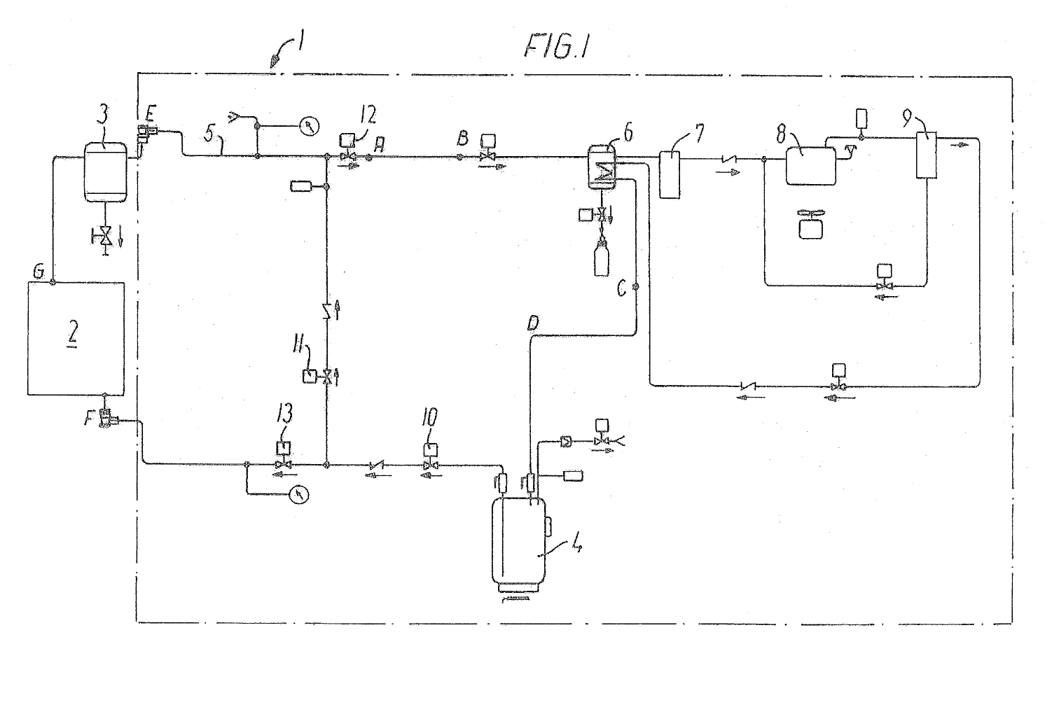

The prior art technology, a service station 1 for the filling, emptying and/or flushing of A/C systems, especially mobile A/C systems (called MAC in the following) 2 is shown in FIG. 1. When using the prior art service station (see FIG. 1) for performing a normal service on the MAC 2, the external flushing accumulator 3, as shown in FIG. 1, is not mounted between the port G on the MAC 2 and the port E on the service station. The coolant is initially withdrawn from the MAC 2 and into the internal cylinder 4. The coolant is sucked into the service station 1 through the port E, which is connected the port G on the MAC by a pipe or hose (not shown). The gaseous coolant is sucked through the service station pipe line 5 and through a heated suction accumulator 6, which will be discussed later, and into the compressor 8, optionally via a filter 7. The gaseous coolant is compressed in the compressor 8, which results in a heated gaseous, or a heated and partially condensed coolant, which is transferred to the internal cylinder 4 via an oil separator 9 and cooling means for the condensation of the coolant prior to storage in the internal cylinder 4. When all the coolant has been withdrawn from the MAC 2, a normal service may be performed.

Prior art service stations normally contain a suction accumulator 6, which basically has the same function as the external flushing accumulators 3. The suction accumulator 6 is, however, a small internal accumulator, since it is not intended to receive large amounts of coolant and just small amounts of oil and particulates, which enter the service station 1 from the MAC 2 during a normal service, i.e. when the MAC 2 is just to be emptied.

When the normal service is completed the MAC 2 is filled with liquid coolant through the port E. Filling is initiated by opening the valves 10 and 11 and closing the valve 12. When filling is completed, the service station is detached from the MAC 2.

When the prior art service station is used for flushing of the MAC 2, a flushing kit comprising an external flushing accumulator 3 is mounted between the MAC 2, and a port E on the service station. The liquid coolant which is stored in the internal cylinder 4 is flushed through the MAC 2 from the port F connected to the liquid side of the MAC 2 and exits the MAC 2 at the port G, normally in gaseous state.

The coolant then enters the external flushing accumulator 3 together with oil and particulates or solids, which are flushed from the MAC 2 by the circulating coolant.

The primary purpose of the externally mounted flushing accumulator 3 in the flushing kit is to catch all the coolant which is flushed through the MAC from the service station as well as the oil and/or any particulates or solids, which are entrained by the coolant flowing through the MAC 2. After collection, it is then the task of the service station to empty the coolant from the accumulator of the flushing accumulator 3 in gaseous form, thereby leaving the oil and any solids or particulates in the flushing accumulator 3.

Since the actual flushing primarily comprises flushing a large amount of liquid coolant from the internal cylinder 4, via open valves 10 and 13 and via the service coupling F through the MAC 2 itself (or the individual component which is to be flushed) and into the flushing accumulator 3, a significant part of the time used in the flushing process is spent on the compressor 8 evacuating the coolant from the flushing accumulator 3 in gaseous form. In some situations, the coolant extracted from the external flushing accumulator 3 is not entirely in gaseous form, i.e. certain amounts of liquid coolant are extracted along with the gaseous phase and sucked into the service station 1. When the compressor 8 sucks out gaseous coolant from the flushing accumulator 3, the coolant is cooled strongly, whereby the pressure in the flushing accumulator 3 decreases. A decreasing pressure also results in a decreasing density, which in turn results in a lower capacity of the compressor 8, i.e. the mass flow drops, and, thereby, the overall time it takes to empty the flushing accumulator 3 increases.

During the flushing procedure, the suction accumulator 6 acts as a cooling means in order to condense the hot, gaseous or partially liquefied coolant prior to storage in the internal cylinder 4 by heat exchange with the cooled gaseous coolant sucked through the suction accumulator 6 by the compressor 8. There is no significant accumulation of oil and/or particulates in the suction accumulator 6 during the flushing procedure, since the most of the oil and/or particulates, which are flushed out of the MAC 2, is collected in the external flushing accumulator 3.

If partially condensed coolant is sucked from the external flushing accumulator 3 during the flushing period, it may be collected in the internal heated suction accumulator 6 and evaporated, partly by being heated by a heating coil in the heated suction accumulator 6, and partly due to the compressor 8 sucking gas from the heated suction accumulator 6.

The oil and/or solids may be extracted from the flushing accumulator 3 when the flushing sequence is completed and the flushing accumulator 3 has been detached from the service station 1.

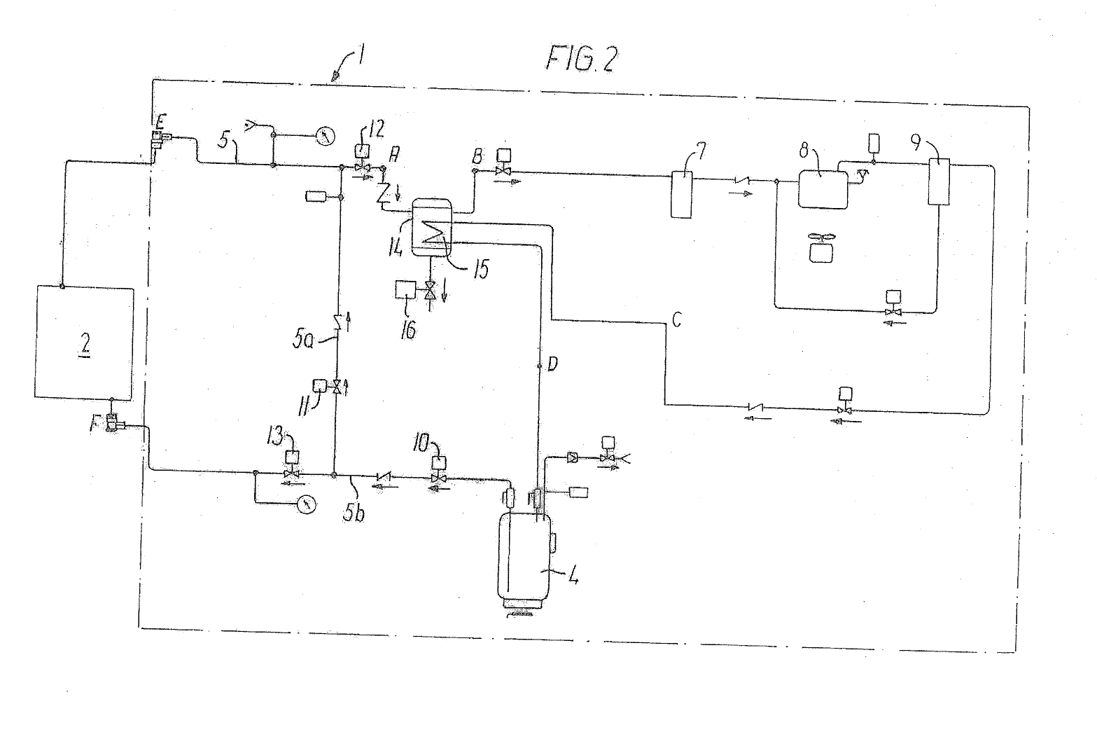

An improved version of the prior art service station is shown in FIG. 2, in which the system according to the invention is shown in a diagram. Features which are also present in the prior art (FIG. 1), are presented using identical reference signs and should not need further explanation.

In the present invention, a flushing accumulator 14 is mounted between the points A and B, which are present inside the service station 1, instead of being mounted externally.

When the flushing accumulator 14 is mounted inside the service station, it is possible to use the waste heat for heating the flushing accumulator 14 via the connection points C+D (FIG. 1), where the hot compressed gaseous coolant from the compressor 8 is used for heating the mixture in the flushing accumulator 14 in a heating coil 15 mounted in the flushing accumulator 14 and thus forming a heated flushing accumulator 14. The hot compressed gaseous, or partially liquefied coolant is cooled and condensed in the heating coil 15 prior to storage as a liquid coolant in the internal cylinder 4. Therefore, the mixture in the flushing accumulator 14 is used for cooling the coolant in the heating coil 15. Thereby, the internally mounted heated flushing accumulator 14 serves a dual function as it acts to catch the coolant, which is flushed through the A/C system from the service station in liquid form, as well as the oil and any solids or particulates which are entrained by the flushing flow of the coolant and also acts in cooling the coolant in the heating coil 15 for condensing the hot, gaseous or partially liquefied coolant prior to storage in the internal cylinder 4. In addition, when the service station 1 is used for recovering coolant during the normal service procedure, the internally mounted heated flushing accumulator 14 also acts to catch oil and/or particulates which escapes from the MAC 2 during coolant recovery.

Similarly to the externally mounted flushing accumulator 3, the compressor sucks out gaseous coolant from the heated flushing accumulator 14, by which the coolant is cooled strongly, whereby the pressure in the heated flushing accumulator 14 decreases.

When the waste heat present in the compressed gaseous coolant leaving the compressor 8, is utilized for heating the coolant/oil/particulates mixture by passing the hot gaseous coolant through the heating coil 15 in the heated flushing accumulator 14, the cooling of the mixture present in the heated flushing accumulator 14, which occurs in the prior art using externally mounted flushing accumulators, may be counteracted, and the full capacity of the compressor may thus be maintained. Therefore, the flushing process will be much faster than the prior art flushing process because the cooling of the coolant in the heating coil (15) and simultaneously the heating of the mixture of coolant, oil and/or particulates present in the heated flushing accumulator 14 is performed in the same flushing accumulator 14.

Oil and/or particulates are preferably withdrawn from the heated flushing accumulator 14 either during the emptying or the flushing procedures by opening a valve 16, e.g. in a fixed and predetermined time interval.

The inside of the service station contains gaskets and connections between the pipe line 5 and the components and is therefore per definition zone 2 area according to ATEX. In order to fulfill zone 2 requirements, the cabinet of the service station 1 according to the invention has a gas-tight cabinet, which is preferably ventilated. Since no external gaskets or connections are present, because the externally mounted flushing kit is eliminated, there is no zone 2 outside the service station, except for the area around the couplings between the service station 1 and the MAC 2, i.e. points F and G, when it is used for performing filling, emptying and/or flushing during service or repair on a MAC 2 comprising an inflammable coolant.

According to the present invention, the suction accumulator 6 used in the prior art service station 1 may also be omitted, as its function will be taken over by the heated flushing accumulator 14. Additionally, when the external flushing kit does not have to be mounted between the service station and the MAC, handling is moreover saved—i.e. the actual flushing process is faster and easier. The simplified construction of the service station and the elimination of the external flushing kit also result in a simplified system which is less expensive to produce.

The present invention also relates to a method of flushing A/C systems, especially mobile A/C systems operating on an inflammable cooling agent. Initially, the service station is coupled to the MAC 2. A service port E is connected to the gaseous side of the MAC 2, and a service port F is connected to the liquid side of the MAC 2. Flushing is performed by opening valves 10 and 13 and closing valve 11, following which liquid coolant flows from the internal cylinder 4 and enters the air conditioning system via pipe line 5b and through the service port F connected to the liquid side of the MAC 2. The coolant circulates through the MAC 2 and captures any oil and/or particulates and leaves the MAC 2 in gaseous form, including any entrained oil and/or particulates, through the service port E. The compressor 8 sucks the mixture of coolant and oil and/or particulates into a heated flushing accumulator 14 mounted inside the service station 1.

Oil and/or particulates are separated from the coolant in the heated flushing accumulator 14 due to the compressor 8 sucking gaseous coolant from the heated flushing accumulator 14. When the gaseous coolant is compressed in the compressor 8, it is also heated. The waste heat transferred to the gaseous coolant in the compressor 8 is used for heating the mixture in the heated flushing accumulator 14 by passing the heated gaseous coolant through the heating coil 15. While heating the mixture in the heated flushing accumulator, the hot gaseous coolant is cooled sufficiently in the heating coil 15 in order to condense, which enables storage of the coolant in liquid form in the internal cylinder 4.

Oil and/or particulates are withdrawn from the heated flushing accumulator 14 in an emptying procedure, which is carried out during the flushing procedure.

The oil and/or particulates are emptied from the heated flushing accumulator 14 through the valve 16 using a timer to control the opening and closing of the valve 16.

Oil which may have been transferred to the circulating coolant by its passage through the compressor 8, is preferably removed in the oil separator 9 prior to cooling in the heating coil 15.

1-16. (canceled)

17. A method for flushing an air conditioning system of a vehicle in a service station, which air conditioning system operates using an inflammable coolant, comprising:
a) flushing the coolant in liquid form from an internal cylinder located in the service station through the air conditioning system;
b) extracting a mixture of gaseous coolant and at least one of oil and particulates from the air conditioning system as a result of the flushing, and passing the extracted mixture to a heated flushing accumulator mounted inside the service station;
c) separating the gaseous coolant from the at least one of oil and particulates in the heated flushing accumulator by a compressor sucking the gaseous coolant from the heated flushing accumulator;
d) condensing the separated coolant by cooling to form liquefied coolant; and
e) transferring the liquefied coolant to the internal cylinder located in the service station.

18. The method according to claim 17, wherein the liquid coolant (i) enters the air conditioning system through a first service port connected to the liquid side of the air conditioning system, and (ii) leaves the air conditioning system in gaseous form, along with the at least one of oil and particulates, through a second service port on the gas side of the air conditioning system.

19. The method according to claim 18, wherein in step d), waste heat transferred to the gaseous coolant by the operation of compressor is used for heating the extracted mixture remaining in the heated flushing accumulator, by transmitting the gaseous coolant from the compressor through a heating coil mounted in the heated flushing accumulator, and wherein the gaseous coolant transmitted through the heating coil is cooled in the transmission process.

20. The method according to claim 19, further comprising:
emptying the at least one of oil and particulates from the heated flushing accumulator.

21. The method according to claim 20, wherein the emptying of the at least one of oil and particulates from the heated flushing accumulator is perfoimed during the flushing procedure.

22. The method according to claim 20, wherein the at least one of oil and particulates from the heated flushing accumulator is emptied through a valve using a timer to selectively control the opening and closing of the valve.

23. A service station for flushing an air conditioning system in a vehicle, which air conditioning system operates using an inflammable coolant, wherein the service system is configured to be coupled to the air conditioning system during the flushing, the service station comprising:
a cabinet in which a pipeline for transporting the coolant connects a first port with a compressor, a cooling unit, an internal cylinder for storing the coolant, and a second port; and
a heated flushing accumulator arranged between the first port and the compressor and configured to (i) collect the coolant which is transmitted from the service station through the air conditioning system, and (ii) heat the collected coolant and simultaneously cool gaseous coolant separated from at least one of oil and particulates contained in a mixture of the gaseous coolant and the at least one of oil and particulates extracted from the air conditioning system as a result of the flushing, prior to storage in the internal cylinder.

24. The service station according to claim 23, wherein the cabinet is gas-tight.

25. The service station according to claim 23, wherein the compressor is used to separate the gaseous coolant from the at least one of oil and particulates, and wherein the heated flushing accumulator includes a heating coil through which the gaseous coolant is transmitted.

26. The service station according to claim 25, wherein the heated flushing accumulator further includes a valve mounted on an outlet through which the at least one of oil and particulates is withdrawn from the heated flushing accumulator.

27. The service station according to claim 23, wherein the pipeline includes valves which are mounted between an outlet on the internal cylinder and the second port.

28. The service station according to claim 27, further comprising:
a valve mounted between the first port and the heated flushing accumulator.

29. The service station according to claim 27, wherein the outlet on the internal cylinder is connected to the first port via a branch of the pipe line, and wherein the branch includes a valve.

30. The service station according to claim 25, further comprising:
an oil separator mounted between the compressor and the heating coil.

31. The service station according to claim 23, further comprising:
a filter mounted between the heated flushing accumulator and the compressor.
